(19) United States
(12) Patent Application Publication
(10) Pub. No.: US 2019/0066017 A1
(43) Pub. Date: Feb. 28, 2019

(54) COUPON OPTIMIZATION SYSTEM

(71) Applicant: Walmart Apollo, LLC, Bentonville, AR (US)

(72) Inventors: Shannon Owens, Centerton, AR (US); Bruce Wilkinson, Rogers, AR (US)

(21) Appl. No.: 16/111,425

(22) Filed: Aug. 24, 2018

Related U.S. Application Data
(60) Provisional application No. 62/549,605, filed on Aug. 24, 2017.

(51) Int. Cl. G06Q 10/06; G06Q 30/02

(52) U.S. Cl. CPC G06Q 10/06315; G06Q 30/0211

(57) ABSTRACT

A system for replenishing store inventory is based on a customer-by-customer prediction of purchasing habits. The customer-by-customer prediction takes into account the likelihood that each customer will purchase a particular type of product, the timing of that likely purchase, and the location where the customer is likely to make the purchase. This information is aggregated and orders for products are made such that products are shipped to the store to arrive just in time for both positive and negative modifications to the overall demand curve caused by a discount, coupon, or other event.

### RELATED APPLICATION

The present application claims the benefit of U.S. Provisional Application No. 62/549,605 filed Aug. 24, 2017, which is hereby incorporated herein in its entirety by reference.

### TECHNICAL FIELD

Embodiments of the present disclosure relate generally to anticipating future demand for products and supply chain management. Embodiments described herein anticipate demand based on aggregated, individual consumer profiles.

### BACKGROUND

Retail stores rely on complex supply chains to ensure that adequate quantities of specific products are received to match demand at each store location. At times, demand for a particular product may exceed available inventory, and stores may be required to take expensive or inconvenient measures such as rushing additional inventory to the store, offering so-called “rain checks” or coupons for the product at a later date, or simply losing sales as customers are unable to acquire the product during an out-of-stock period.

One way to avoid out-of-stock conditions, as well as avoiding workarounds such as rain checks or expensive rush restocking shipments, is to maintain higher levels of inventory at a store. Relatively higher levels of inventory can be stocked before expected peaks in demand. Those peaks can be related to major shopping events, and can be product-specific. For example, conventional restocking and replenishment orders can be adjusted upwards in advance of an expected increase in demand related to, e.g., Black Friday sales, holidays, or seasonal sales trends and related weather events.

Increases in inventory require the use of storage space, either on the shelves, over the top of the shelves, or in a storage or inventory space. Demand for this space is quite high, and storing excess product inventory is expensive and inconvenient. In some cases, excess inventory will be sold off over time. For other types of products, however, such as perishable items or seasonal items, ordering excess inventory of a particular product not only wastes internal storage and shelf space but also can lead to products that languish in the store and may never be sold, resulting in financial losses for the retailer.

Systems for monitoring and analyzing sales data corresponding to a sale, coupon, event, or holiday are conventionally based upon a store-by-store or region-by-region analysis. Conventionally, demand forecasting that is associated with a product, set of products, specific target locations, manufacturers, and businesses can be conducted by defining an endpoint, a midpoint, or some other “critical date” for a promotion and schedule shipments for product replenishment to arrive by that date.

### SUMMARY

In an embodiment, a system for matching inventory replenishment to a demand peak includes a database of customer profiles, a database of manufacturers' historical and future coupon attributes, a cross-reference linking the coupon's intended merchandise to the retail system's item file to ensure that the applicable item(s) identified are those that are considered for replenishment, an analytical engine, and a replenishment subsystem. Each of the customer profiles corresponds to a consumer. The analytical engine is configured to compare each of the customer profiles to a discount event to determine a likely demand function for each of the customer profiles, and weight the likely demand functions corresponding to each of the customer profiles based upon a corresponding consumer location. The comparison can consider all of the attributes of a discount such as a coupon, including when and where the coupon will be used, or even if the customer profile indicates that there is a probability that the coupon will be used at all. The analytical engine is then configured to aggregate the weighted likely demand functions corresponding to each of the customer profiles to generate an overall demand modification curve corresponding to the discount event. The replenishment subsystem causes a product to be shipped to a store based upon the overall demand modification curve corresponding to the discount event.

In embodiments, each of the customer profiles comprises corresponding consumer location, historical data related to a set of types of discount events the corresponding consumer has participated in, and, for each of the set of types of discount events the corresponding consumer has participated in, temporal information regarding the participation. The temporal information regarding the participation can include how many days after a past discount event the corresponding consumer made a purchase. Alternatively, the temporal information regarding the participation relates to how many days before the end of a past discount event the corresponding consumer made a purchase. The temporal information can also include at least one of days of the week or days of the month on which the consumer made a purchase during a past discount event.

In embodiments, the overall demand modification curve is an amplitude of additional sales expected as a function of time due to the discount event. The replenishment subsystem can be configured to cause the product to be shipped such that the product arrives in advance of a positive portion of the overall demand modification curve. Additionally, the replenishment subsystem can be configured to reduce a shipment quantity based upon a negative portion of the overall demand modification curve.

The analytical engine can be configured to update the overall demand modification curve based upon actual sales of the product during the discount event, in embodiments.

According to another embodiment, a method for matching inventory replenishment to a demand peak includes collecting a database of customer profiles, comparing each of the customer profiles to a discount event to determine a likely demand function for each of the customer profiles, weighting the likely demand functions corresponding to each of the customer profiles based upon a corresponding consumer location, aggregating the weighted likely demand functions corresponding to each of the customer profiles to generate an overall demand modification curve corresponding to the discount event, and shipping a product to a store based upon the overall demand modification curve corresponding to the discount event. Each of the customer profiles corresponds to a consumer and includes corresponding consumer location information, historical data related to a set of types of discount events the corresponding consumer has participated in, and, for each of the set of types of discount events the corresponding consumer has participated in, temporal information regarding the participation.

The method can further include corresponding the customer profiles to the discount event, weighting the likely demand functions, and aggregating the weighted likely demand functions performed by an analytical engine. The temporal information regarding the participation can relate to how many days after a past discount event the consumer made a purchase, or how many days before the end of a past discount event the consumer made a purchase. The temporal information can include at least one of days of the week or days of the month upon which the consumer made a purchase during a past discount event.

The overall demand modification curve can be an amplitude of additional sales expected as a function of time due to the discount event. The replenishment subsystem can be configured to cause the product to be shipped such that it arrives in advance of a positive portion of the overall demand modification curve. The replenishment subsystem can further be configured to reduce a shipment based upon a negative portion of the overall demand modification curve.

The analytical engine can be configured to update the overall demand modification curve based upon actual sales of the product during the discount event. Weighting the likely demand functions can include weighting the customer profiles associated with customers closer to a location of the discount event more heavily than customer profiles associated with customers further from the location of the discount event.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a demand curve corresponding to a particular product.

FIG. 2 depicts a demand curve of FIG. 1, as well as a modified demand curve.

FIG. 3 is a flowchart depicting a system for predicting a modified demand curve according to an embodiment.

FIG. 4 depicts a variance from an expected demand curve.

FIG. 5 is a flow chart of a dynamic control loop according to an embodiment.

FIG. 6 is a demand curve and a corresponding replenishment curve according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

A system for ordering inventory can take into account past sales and analyze the effects of discounts, events, or other special circumstances that influence the sales of particular products. Based on those data, the system can predict how much of a product will be needed as a function of time, ordering additional inventory just in time to meet demand so that customers will not experience the frustration of out-of-stock events, and so that excess inventory will not take up valuable storage space or go unsold.

In embodiments, an algorithm predicts whether a customer will use each individual coupon whatsoever, as well as when and where the use is likely to occur. A given customer may respond only to coupons for certain merchandise categories (household cleaning products or dairy), or to certain incentive types (level of savings such as buy-one-get-one (BOGO) ½ price, BOGO free, $1 off, $2 off, $5 off on 3, etc.), or only to certain combinations of coupon attributes (i.e. household cleaning product category having incentive type BOGO,; frozen pizza category having>=$1 off).

Discrete events such as holidays, back-to-school, or seasonal changes in shopping habits result in changes to demand for individual products. Those differences are monitored so that inventory matches demand for subsequent, similar events. Likewise, sales and coupons can make an impact on overall sales that can be monitored and used to appropriately stock stores for subsequent, similar events.

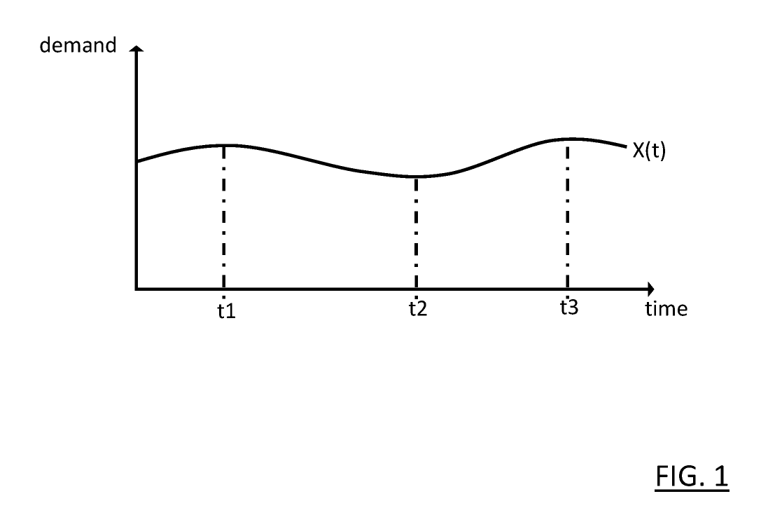

FIG. 1 is a chart of demand versus time showing demand X(t) as a function of time for a particular product. X(t) varies over time, even without a particular sale, coupon, or other event. Variations can be random or natural, or they can be related to regular, recurring shopping patterns. For example, at t1 a relative maximum in X(t) can be related to a weekend. Later, a relative minimum t2 in X(t) occurs during the week when shopping is not as common for the particular product related to X(t). Another relative maximum in X(t) occurs at a third time point t3, which can be related to a weekend as with t1, or could be due to some other factor such as the beginning of a new month, or a weather event, for example.

For some demand functions X(t), variation can occur due to interactions between multiple factors, such as the first weekend after the beginning of a new month, or a weather event and a change of seasons, among others. X(t) can have annual, weekly, monthly, or other cyclical variations, for some products, or for other products may be relatively flat. Each product can have a distinct demand function X(t). Furthermore, X(t) can vary by store or location for some products.

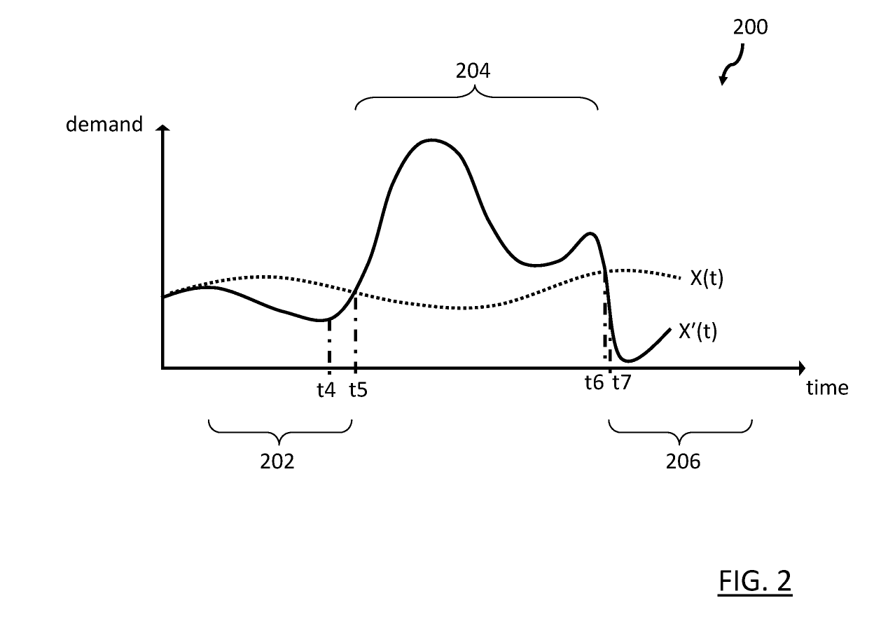

FIG. 2 shows X(t) that was previously described with respect to FIG. 1. In FIG. 2, X(t) is shown as a dotted line. X(t) is the unmodified, natural demand curve for a particular product at a particular location.

X′(t), in contrast, is a modified demand curve at the same location. X′(t) can be modified from the natural demand curve X(t) due to a variety of factors. For example, a coupon or some other similar discount event can result in a modified demand curve X′(t). As described herein, the modification that results in a change from demand curve X(t) to modified demand curve X′(t) is created by the manufacturer or retailer. In other embodiments, the modification could be caused by some other event, such as a declaration of a severe weather event or a major event held nearby.

Thus FIG. 2 shows two demand curves: the unmodified, normal, or expected demand X(t), and the actual demand after modification due to some coupon, discount, or other event X′(t). In FIG. 2, the modification is the result of the publication of a coupon.

At time t4, a coupon becomes active. In embodiments, the coupon could be a printed coupon, such as one available in a newspaper or circular. In alternative embodiments the coupon could be a digital coupon. In still further embodiments, the coupon could be a personalized (rather than generic or regular circulation) coupon, such as a voucher that is sent to a specific customer. As the term is used throughout this application, a “coupon” can be used to refer to a discount that requires the consumer to take a physical or digital copy to the store in order to be redeemed, or it could be used to refer to any other type of discount that is available even without obtaining a printed or digital code or offer. In advance of the coupon becoming redeemable, modified demand curve X′(t) may be lower than the natural demand curve X(t). For some discounts, this may be because individual customers are delaying a purchase until the effective date of the coupon. In other embodiments, the coupon or other discount can be generated in order to respond to an unexpected decrease in sales, to avoid the undesirable effects described above relating to an excess of inventory of a particular type of product.

At time t5, modified demand curve X′(t) crosses natural demand curve X(t). In the time before t5, negative modification portion 202, modified demand curve X′(t) shows lower overall demand than the demand associated with natural demand curve X(t). That is, the coupon or discount decreases overall demand in the time period leading up to the active date of the coupon or discount at t4 (and, in this instance, for a short time thereafter). During negative modification portion 202, less inventory may need to be shipped to stores compared to the amount that would normally be shipped in the absence of the impending coupon or discount.

After time t5, a positive modification portion 204 begins. During positive modification portion 204, modified demand curve X′(t) exceeds the natural, unmodified demand curve X(t). During positive modification portion 204, additional inventory may need to be shipped to stores compared to the amount that would normally be shipped in the absence of the coupon or discount.

At time t6, modified demand curve X′(t) and natural demand curve X(t) intersect once again. Short1y thereafter, at time t7, the discount or coupon event ends. After time t6, another negative modification portion 206 begins. This negative modification portion 206 can be caused by consumers who shift purchases of a product to an earlier time in order to benefit from the coupon or discount.

For some products, X(t) and X′(t) will overlap one another some time after the discount or coupon event. In other embodiments, such as for a discount meant to introduce consumers to a new product or a product improvement, modified demand curve X′(t) can be permanent1y or semi-permanent1y higher than the original, natural demand curve X(t). Subsequent sales or coupons can result in further modified demand curves X″(t) (not shown).

Less desirably, in some cases a poorly managed discount or coupon event, or a new product release for a defective or otherwise unsatisfactory product, can result in a permanent or semi-permanent decrease in modified demand X′(t) compared to the original, natural demand curve X(t). Subsequent sales or coupons can result in further modified demand curves X″(t) (not shown).

In general, it is desirable to predict the difference between the modified demand curve X′(t) and the natural demand curve X(t). By predicting the amplitude of the difference between these two curves X(t) and X′(t), a supply chain can be tailored to a particular event (e.g., coupon or discount) to result in just-in-time inventory replenishment, reducing the likelihood of an out-of-stock event while also reducing the need for excessive use of storage or shelf space at the retail store.

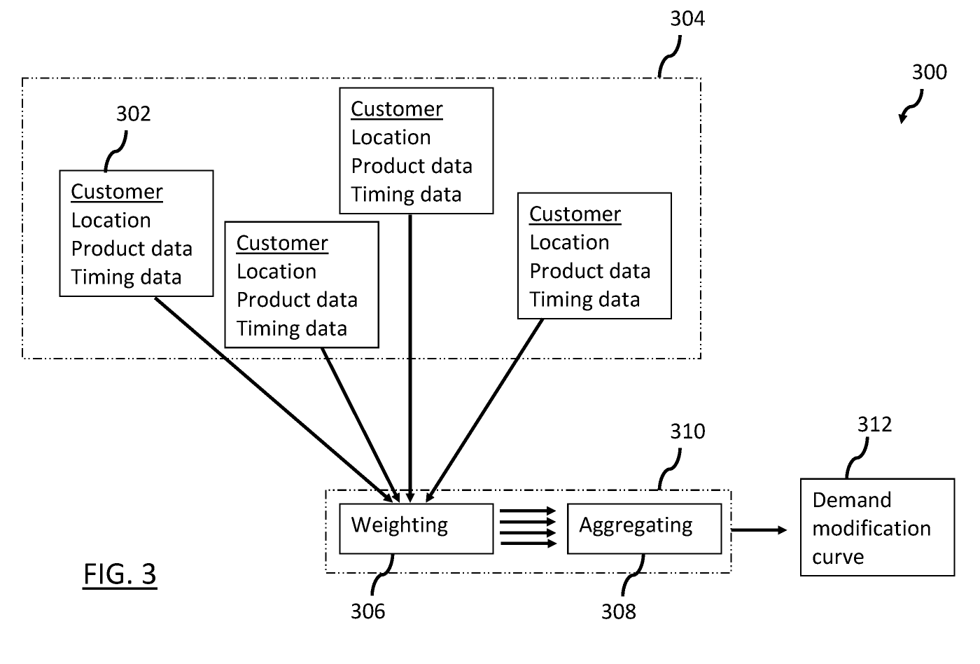

FIG. 3 is a schematic showing a system 300 for generating a modified demand curve (e.g., modified demand curve X′(t) of FIG. 2). As shown in FIG. 3, four customer profiles 302 are stored within data storage 304, which can be, for example, a database storing customer profiles 302. The data from each of these customer profiles 302 is sent from data storage 304 to be weighted at weighting block 306, as described in more detail below. The weighted customer profile data is sent for aggregation at aggregation block 308, as described in more detail below. The weighted, aggregated customer profile is then used to determine a demand modification curve at block 312.

In embodiments, weighting and aggregation of the customer profile data is conducted at an analytical engine 310. In alternative embodiments, calculation of a demand modification curve at block 312 can also be conducted by analytical engine 310.

Customer profiles 302 contain information relating to individual customers. As shown in FIG. 3, each of these customer profiles includes information including a typical location or locations associated with the customer based on their shopping habits, data relating to the types of products purchased by the customer in the past, as well as timing data, which can give an indication of the temporal aspects of the purchasing patterns of the customer associated with each respective customer profile 302. In embodiments, a customer profile can be linked to a payment method such as a credit or debit card, for example. Purchases associated with that credit card or debit card are analyzed for purchasing patterns. In alternative embodiments, different “keys” or unique identifiers could be used to link together purchases into a customer profile. For example, retailers with an online presence for deliveries or those that allow for preordering of merchandise to be picked up in-store may be linked together by identifying features such as an IP address or customer login or other account.

Purchase data can include aggregated transaction data received from a plurality of retail sites. Each retail site can have a number of transaction processing systems which each include point-of-sale (POS) systems such as cash registers, or transaction aggregation servers. A transaction processing system can be in continuous or intermittent data communication with a transaction data store in order to provide transaction data records for each retail transaction.

Each transaction data record can include the monetary value and the payment method (such as cash, gift card, check, credit or debit card, or the like) for each transaction. Transaction data records can further include links to, or be otherwise associated with, the retail site, market and/or region where the transaction took place, customer information (if available), and an indication of the items, which can be goods or services involved in the transaction. A transaction data store can reside within a single database system, or can comprise a distributed file system, or other storage mechanisms such that transaction data store resides across multiple computing systems.

System 300 can therefore comprise, or be communicably coupled to the transaction data store, or the transaction processing system to receive transaction data as new transaction records are created. System 300 can present one or more network interfaces to receive data (including transaction data, and other customer profile information), and provide outputs to one or more user devices.

Product data information within each customer profile 302 can include the types of products that the associated customer purchases, the quantity typically purchased, and whether those purchases are motivated by advertisements, coupons, or discounts.

Timing data within each customer profile 302 is temporal and related to the customer data, in that timing data relates to when the purchases are made. Some consumers are likely to use a coupon or take advantage of a discount as soon as it becomes available. This type of consumer is responsible for the initial, large peak shown in FIG. 2 just after time t5. Other consumers may be last-minute users of coupons or discounts. Those consumers are responsible for the second, smaller peak in FIG. 2, just before time t6.

The timing or temporal information regarding a particular consumer can relate to how that consumer interacts with discount events. Timing information can include how many days after a past discount event the corresponding consumer made a purchase, in some embodiments. Alternatively, the timing information regarding the participation relates to how many days before the end of a past discount event the corresponding consumer made a purchase. In other embodiments, timing or temporal information or data can be more granular, such as down-to-the-hour or -minute data for short-term events.

Timing data can include more than just information relating to coupon or discount events. For example, certain customers may routinely shop on a specific day of the week, or a specific time within the month. Timing data can, in some embodiments, even include information relating to what time of the day (e.g., morning, noon, afternoon, evening) the customer is likely to shop. System 300 can therefore determine whether that particular customer is likely to take advantage of a discount, coupon, or other sale that takes place during a particular time of the day, such as a flash sale or sale with a very limited duration.

By combining temporal and product data, each customer profile 302 becomes a unique profile for an individual customer. The customer profile 302 first provides an indication of how likely that customer is to take advantage of a particular discount or coupon. But more than that, the customer profile 302 indicates when the customer is likely to take advantage of the discount or coupon.

Customer profile can include fields such as Customer ID; Customer location (zip, zip+4, CBSA, etc.); price point tendency (low, medium, high); percent promotion in the average transaction; preferred store format; a preferred store number; a preferred store distance or range; the format of the store nearest the customer; the nearest store number; the nearest store distance to the customer; the promotional tendency (BOGO ½ price, BOGO free, $1 off on 1, $5 off 3); a percentage of transactions where the customer used promotions; the day of the week that the customer typically shops; the time of day that the customer typically shops; the time of day and day of week that the customer typically shops (in combination); the customer's gender; the customer's marital status; the number of children in the customer's household; the customer's age; interest identifiers (healthy lifestyle, organic, health interest, weight conscious); the customer's income range; or other information that helps to classify the interests and preferences of the customer.

Weighting of the customer profile data takes place at block 306. Weighting not only considers whether a customer is likely to purchase a product and when, but also considers where the customer is located based on the location data within each set of customer profile 302. Weighting 306 therefore provides a likelihood of a product purchase by a specific customer, at a specific time, and within a certain location. At weighting block 306, the customer data is still separated; that is, system 300 is determining on a customer-by-customer basis whether a purchase is likely to take place.

Aggregating 308 combines the probabilities of sales associated with each customer, at each location, at each time, into one master demand curve (e.g., X(t)). Where the demand curve is being calculated based upon an event such as a coupon, discount, new store opening, store closing, weather event, or something else that affects a typical demand curve, the difference between the demand curve X(t) and the modified demand curve X′(t) is calculated at block 312. This difference, which is the amplitude of the difference between X(t) and X′(t) shown in FIG. 2, can be used to modify inventory replenishment shipments in advance of an expected increase or decrease in demand.

Unlike conventional systems, the demand modification curve calculated by system 300 is localized on a customer-by-customer basis, rather than relying on macro trends at a store-by-store or region-by-region basis. For example, if a customer moves then the customer profile 302 relating to that customer can be updated with new location information such that weighting block 306 will not take that customer's information into consideration at the old address, and weighting block 306 will take that customer's information into consideration at the new address. System 300 is therefore configured to more rapidly adjust to movement of customers, changes in the purchasing habits of customers, and local trends than systems that rely on non-individualized data.

In some embodiments, system 300 is associated with a particular location. That is, a retailer may store many customer profiles 302 but only the ones within a particular location are used to determine impact on sales relating to a local discount, coupon, or other event. In that case, modified demand curves can be produced for each of a series of locations. Such demand curves, which are based on both time and location, are referred to herein as X′(t, x).

Such systems can be used to manage inventory for types of discounts that would otherwise be difficult or impossible to manage using conventional, region-by-region or store-by-store data rather than customer-by-customer data. For example, some retailers offer coupons or discounts that become available to the consumer a certain number of days after another purchase. In one example, a consumer may receive a coupon good for a certain percentage off of his or her next purchase, and the coupon may become effective a week after the initial purchase. Regional or store-by-store data cannot be used to predict the impact in demand that this coupon will make. Customer-by-customer data, weighted and aggregated as shown in FIG. 3, makes tracking this difference quite simple. The coupon is linked to the temporal and product preferences of that individual consumer, and the stores that may experience a modified level of demand can be determined based on the customer's location information. If these coupons are handed out to a large number of customers, the modified demand level for products could vary significant1y, which is predicted by the aggregated data at block 308 that is used to generate the demand modification curve at block 312.

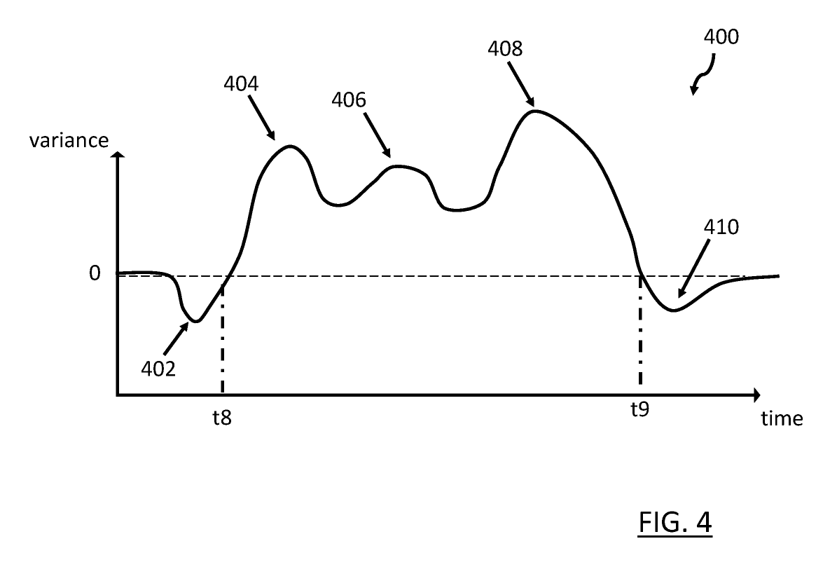

FIG. 4 depicts a variance curve 400. As shown in FIG. 4, an event begins at time t8 and ends at time t9. Prior to time t8, variance between the modified demand and the typical demand for a product is zero. A decrease in demand is shown as local minimum 402. Local minimum 402, as described above, can be related to time-shifting of purchases by individual consumers who are aware that a sale or discount is going to begin soon, for example. After the beginning of a discount or coupon, sales increase to a local maximum 404 related to early shoppers.

A second local maximum 406 can relate to some other factor, such as a weekend or a weather event. A weather event may cause an increase in both the normal demand function X(t) and the modified demand curve X′(t), in which case the variance (i.e., the difference between X(t) and X′(t)) should be zero. The impact on sales caused by a weather event in combination with a discount or coupon, however, may be larger or smaller than the impact that the weather event would have caused in isolation.

A third local maximum 408 can be caused by consumers who wait to use a coupon or take advantage of a discount before its expiration. A local minimum 410 follows the expiration of the coupon or discount event, due to time-shifting of purchases that would have been made later but for the discount or coupon.

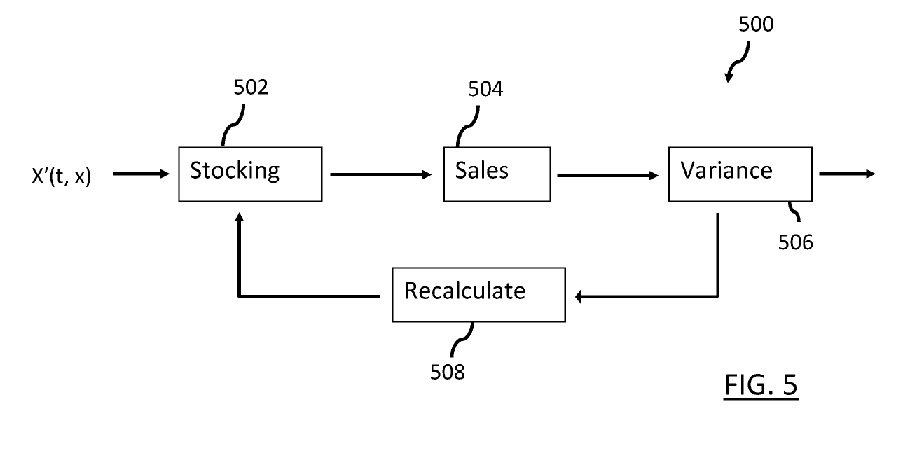

FIG. 5 is a dynamic control loop that updates a modified demand curve X′(t, x) in real time. The modified demand curve is used at 502 to stock shelves in advance of a negative or positive amplitude portion of the variance curve described above with respect to FIG. 4. At block 504, sales occur that modify the level of available inventory, as well as providing information regarding which customers have made purchases of which products.

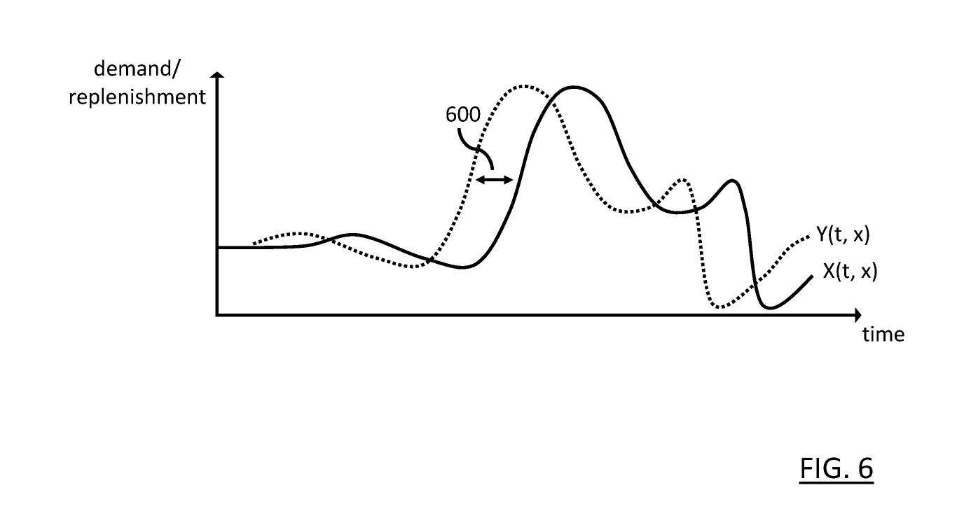

At 502, stocking involves calculating the desired quantity of product needed to replenish a store or other retail facility or set of facilities. Stocking 502 further includes determining how far in advance a product should be requested or shipped such that it will arrive in time for the expected level of demand. Determining the expected level of demand is described in more detail above, while determining the appropriate lead time for stocking or restocking at 502 is described in more detail below with respect to FIG. 6.

Data from sales 504 can be used in multiple ways. First, sales 504 can be used to update individual customer data (e.g., customer profile 302 of FIG. 3). Each additional purchase by a particular customer can be used to determine, with more certainty, what types of products that consumer is likely to purchase, at what time during the coupon or discount event that the consumer is likely to make a purchase of those products, and the location where the consumer is most likely to make a purchase, as described in more detail above. Likewise, data from sales 504 indicates that inventory has been reduced in the particular location where the sale was made. As inventory decreases, additional stock may need to be ordered to replenish the store.

At block 506, a variance is calculated. If actual sales at a time t and a location x are not consistent with the expected number of sales predicted by modified demand curve X′(t, x) then the curve may need to be adjusted. For example, a predicted amplitude of X′(t, x) can be based on the amount of a discount or coupon, but based on actual sales at block 504 it may become clear that the response to the discount or coupon is greater than predicted. In that case, the weighting function (e.g., weighting block 306 of FIG. 3) can be adjusted to account for the variance at block 506. At block 508, the modified demand function X′(t, x) is recalculated based on the variance, if any, between sales at block 504 and the original modified demand function X′(t, x).

FIG. 6 depicts a demand curve X(t, x) and a replenishment curve Y(t, x). As described above with respect to stocking 502, the demand curve X(t,x) can be used to determine a quantity of products that are needed for stocking at each store or other facility. Replenishment curve Y(t,x) takes into account not only the quantity of a product needed as set forth in X(t,x) but also the shipping time for those products, including logistics system timing, such that the products will arrive just in time for the expected demand associated with each product.

As shown in FIG. 6, an ideal replenishment curve is phase-shifted to an earlier time than the demand curve by a gap 600. Gap 600 takes into account the necessary time for ordering, shipping, and stocking the particular product at a store. For example, in embodiments it may be desirable to order products to be shipped to a store a week or more before they will actually be sold. FIG. 6 demonstrates the importance of not only determining the extent of a demand modification caused by some event, but also the extent of that modification as a function of time. Knowing the net change in demand caused by a particular sale is useful, but if all of the product is shipped prior to the beginning of a sale or discount, the store may have to store large quantities of that inventory until late in the sale or discount period. Matching the time of the order to the time of the sales requires a properly sized gap 600, which is calculated based upon the factors described above. Improvements to the quality of the anticipated day-by-day or even hour-by-hour demand curves results in product arriving at a store just in time to be sold, improving efficiency at the store and reducing the potential for unsold or overstocked products.

The replenishment curve can be provided to a replenishment subsystem, which can be communicable coupled (for example, via a wired or wireless network connection) to direct1y system 300, or indirect1y via a common data storage system. The replenishment subsystem can be operably coupled to one or more logistics systems to cause a product to be shipped to a store based upon the overall demand modification curve and the replenishment curve corresponding to the discount event. The replenishment subsystem can be configured to cause the product to be shipped such that the product arrives in advance of a positive portion of the overall demand modification curve. Additionally, the replenishment subsystem can be configured to reduce a shipment quantity based upon a negative portion of the overall demand modification curve.

Embodiments of the present disclosure facilitate replenishment such that product arrives at the necessary locations in the projected quantities just prior to an expected demand spike. This facilitates optimal on-shelf availability of product, preventing lost sales and inhibiting overloading of back room functions. In addition, embodiments help reduce unnecessary over-ordering, which can lead to inefficiencies.

In one embodiment, the systems disclosed herein and/their components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain, or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, each system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application-specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed different1y among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for matching inventory replenishment to a demand peak, the system comprising:
a database of customer profiles, each of the customer profiles corresponding to a consumer;
an analytical engine configured to:
compare each of the customer profiles to a discount event to determine a likely demand function for each of the customer profiles,
weight the likely demand functions corresponding to each of the customer profiles based upon a corresponding consumer location, and
aggregate the weighted likely demand functions corresponding to each of the customer profiles to generate an overall demand modification curve corresponding to the discount event; and
a stocking subsystem that causes a product to be shipped to a store based upon the overall demand modification curve corresponding to the discount event.

2. The system of claim 1, wherein each of the customer profiles comprises:
the corresponding consumer location;
historical data related to a set of types of discount events the corresponding consumer has participated in; and
for each of the set of types of discount events the corresponding consumer has participated in, temporal information regarding the participation.

3. The system of claim 2, wherein the temporal information regarding the participation relates to how many days after a past discount event the corresponding consumer made a purchase.

4. The system of claim 2, wherein the temporal information regarding the participation relates to how many days before the end of a past discount event the corresponding consumer made a purchase.

5. The system of claim 2, wherein the temporal information includes at least one of days of the week or days of the month on which the consumer made a purchase during a past discount event.

6. The system of claim 1, wherein the overall demand modification curve is an amplitude of additional sales expected as a function of time due to the discount event.

7. The system of claim 6, wherein the stocking subsystem is configured to cause the product to be shipped such that the product arrives in advance of a positive portion of the overall demand modification curve.

8. The system of claim 6, wherein the stocking subsystem is further configured to reduce a shipment quantity based upon a negative portion of the overall demand modification curve.

9. The system of claim 1, wherein the analytical engine is configured to update the overall demand modification curve based upon actual sales of the product during the discount event.

10. A method for matching inventory stocking to a demand peak, the method comprising:
collecting a database of customer profiles, each of the customer profiles corresponding to a consumer and including:
a corresponding consumer location,
historical data related to a set of types of discount events the corresponding consumer has participated in, and
for each of the set of types of discount events the corresponding consumer has participated in, temporal information regarding the participation,
comparing each of the customer profiles to a discount event to determine a likely demand function for each of the customer profiles;
weighting the likely demand functions corresponding to each of the customer profiles based upon a corresponding consumer location;
aggregating the weighted likely demand functions corresponding to each of the customer profiles to generate an overall demand modification curve corresponding to the discount event; and
shipping a product to a store via a stocking subsystem based upon the overall demand modification curve corresponding to the discount event.

11. The method of claim 10, wherein comparing the customer profiles to the discount event, weighting the likely demand functions, and aggregating the weighted likely demand functions are performed by an analytical engine.

12. The method of claim 10, wherein the temporal information regarding the participation relates to how many days after a past discount event the consumer made a purchase.

13. The method of claim 10, wherein the temporal information regarding the participation relates to how many days before the end of a past discount event the consumer made a purchase.

14. The method of claim 10, wherein the temporal information includes at least one of days of the week or days of the month upon which the consumer made a purchase during a past discount event.

15. The method of claim 10, wherein the overall demand modification curve is an amplitude of additional sales expected as a function of time due to the discount event.

16. The method of claim 15, wherein the stocking subsystem is configured to cause the product to be shipped such that it arrives in advance of a positive portion of the overall demand modification curve.

17. The method of claim 15, wherein the replenishment subsystem is further configured to reduce a shipment based upon a negative portion of the overall demand modification curve.

18. The method of claim 10, wherein the analytical engine is configured to update the overall demand modification curve based upon actual sales of the product during the discount event.

19. The method of claim 10, wherein weighting the likely demand functions comprises weighting the customer profiles associated with customers closer to a location of the discount event more heavily than customer profiles associated with customers further from the location of the discount event.
